(19) United States
(12) Patent Application Publication
(10) Pub. No.: US 2008/0225531 A1
(43) Pub. Date: Sep. 18, 2008

(54) METHODS AND APPARATUS FOR FAUX CAN LIGHTING

(76) Inventors: David S. Shiller, Pittsburgh, PA (US); Gary W. Broyer, Sparta, NJ (US)

Correspondence Address: DALY, CROWLEY, MOFFORD & DURKEE, LLP, SUITE 301A, 354A TURNPIKE STREET, CANTON, MA, 02021-2714, US

(21) Appl. No.: 12/045,961

(22) Filed: Mar. 11, 2008

Related U.S. Application Data
(60) Provisional application No. 60/894,318, filed on Mar. 12, 2007.

(51) Int. Cl. F21V 15/00

(52) U.S. Cl. 362/365

(57) ABSTRACT

Methods and apparatus for a flush mounted CFL downlight. In an exemplary embodiment, a downlight lighting device includes a base adapted for engagement to a surface of a structure, a compact fluorescent lamp (CFL) coupled to the base, and a ballast integrally coupled to the base and electrically coupled to the CFL, the ballast and the CFL being generally parallel, wherein the device is configured to be flush mounted on the surface.

### CROSS REFERENCE TO RELATED APPLICATIONS

The present application claims the benefit of U.S. Provisional Patent Application No. 60/894,318, filed on Mar. 12, 2007, which is incorporated herein by reference.

### BACKGROUND

As is known in the art, incandescent recessed lights have been in use for many years. Such lights may provide adequate illumination, however, certain drawbacks exist. For example, incandescent lamps are relatively energy inefficient and generate significant heat. Attempts have been made to utilize other technologies with limited success. For example, LED (light emitting diode) products may address some incandescent disadvantages, but are relatively costly and provide limited illumination. CFL (compact fluorescent lamp) products have been used in products, such as the PowerLux Part Number [PR120N18/27]. However, this product has certain aesthetic shortcomings due to the nature of CFLs. In particular, the PowerlLux product undesirably extends significantly below the ceiling into which the product is installed.

The PowerLux product attempts to solve some of the heat related issues connected to fluorescents in recessed can applications, however disadvantages still exist. The product requires a standard recessed can for mounting that requires a hole be cut into the ceiling. This leaves an open place for ambient air to escape—cooled air in the warmer months, and heated air in the cooler months.

### SUMMARY

The present invention provides methods and apparatus for a compact fluorescent lamp (CFL) downlight that is flush-mounted on a surface, such as a ceiling. With this arrangement, heat build up is reduced as compared with recessed CFL configurations so as to increase ballast durability and performance. In addition, only a relatively small hole needs to be cut into the ceiling.

In one aspect of the invention, a lighting device comprises a housing adapted for engagement to a surface, a ballast integrally coupled to the base and electrically engageable to a CFL, the ballast and the CFL being generally parallel, wherein the device is configured to be flush mounted on the surface.

The device can further include one or more of the following features: the compact fluorescent lamp (CFL) coupled to the base, the device includes a GU24 plug for coupling with a GU24 socket, the ballast and the lamp are integral to the device such that failure of the ballast and/or lamp is addressed by replacement of the device, a distance the device extends below the surface is less than about one inch, a distance the device extends below the surface is less than about one-half inch, the device flush-mounts to a four inch electrical box, a cross bar coupled to the GU24 socket to secure the socket to the electrical box, and a mechanism to enable the GU24 socket to move into and out of the electrical box for flushmounting of the device on the surface.

In another aspect of the invention, a flush mountable CFL downlight device comprises a housing, a ballast secured to the housing, a screw in CFL coupled to the housing adapted for being energized by the ballast, wherein the ballast and the CFL are generally parallel, and a GU24 plug extending from the housing, wherein the device is flushmountable to a ceiling.

In a further aspect of the invention, a method comprises forming a four square inch hole in a ceiling, installing an electrical box in the hole, and flush mounting a CFL downlight device on the ceiling.

The method can further include one or more of inserting a GU 24 plug extending from the device into a GU24 socket secured to the electrical box, securing the GU24 socket to the electrical box with a floating and movable cross bar, adjusting a mechanism to make the device flush with the ceiling, and mounting the device such that the device extends less than about one inch down from the ceiling.

### BRIEF DESCRIPTION OF THE DRAWINGS

The foregoing features of this invention, as well as the invention itself, may be more fully understood fi-om the following description of the drawings in which:

FIG. 1 is a top view of a lighting device in accordance with exemplary embodiments of the invention;

FIG. 1A is cross-sectional view of the lighting device of FIG. 1;

FIG. 2 is a schematic representation of a flush mount CFL downlight device in accordance with exemplary embodiments of the invention;

FIGS. 3 and 4 show partial installations for the downlight device of FIG. 2;

FIGS. 4A-F shows an exemplary cross bar mechanism for the device of FIG. 2;

FIG. 5 is a diagrammatic representation of installation holes;

FIGS. 6A and 6B are prior art recessed can installations; and

FIG. 6C is a pictorial representation of an installed faux can.

### DETAILED DESCRIPTION

The present invention provides methods and apparatus, generally referred to as faux can, to provide a downlight lighting device that has some commonality in appearance with traditional recessed lighting fixtures but with certain advantages. Exemplary embodiments of the invention, which can be referred to as a faux can lighting device, provide a compact fluorescent light that is flush-mounted on a surface. The lighting device generates light in a downward direction when mounted on a ceiling, for example. In exemplary embodiments, the inventive faux can device appears to have similarity to a recessed downlight trim kit, however, the inventive device is not recessed, but rather is flush mounted.

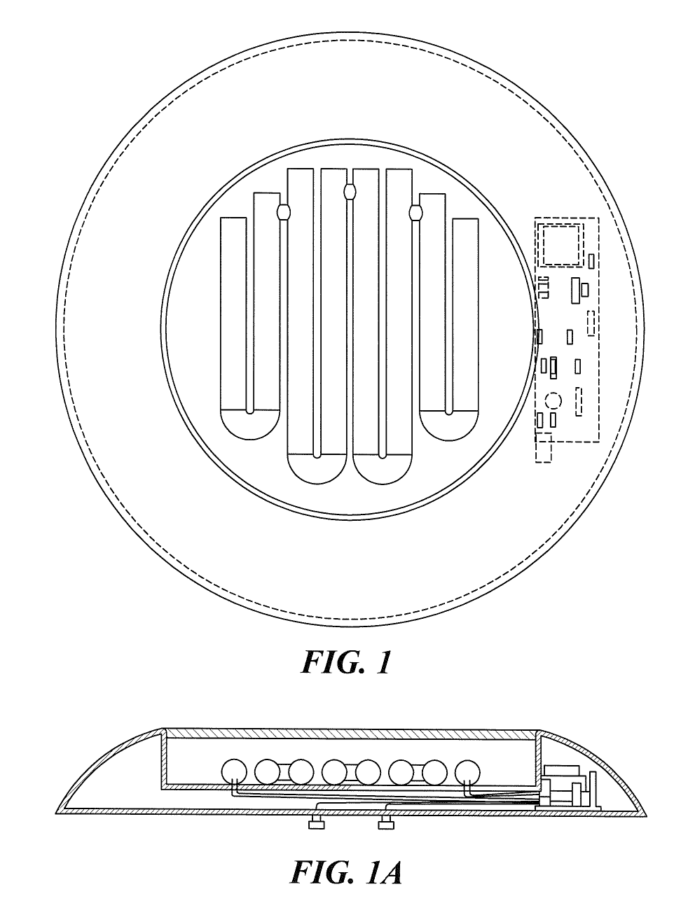

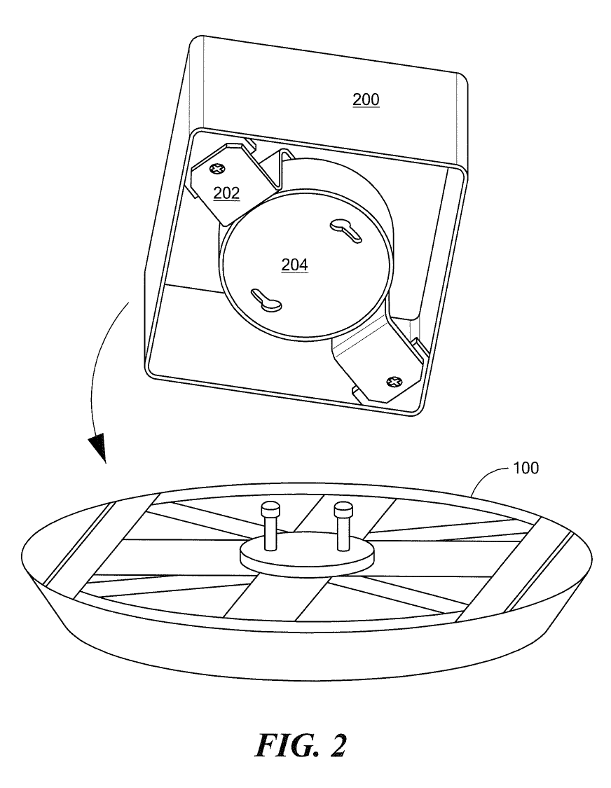

FIGS. 1 and 1A show an exemplary faux can downlight lighting device 100 having a CFL lighting source 102 and an electronic ballast 104 coupled to a housing or base 106. An external portion 108 of the housing provides the trim for the lighting device.

The trim 108 is used for recessed light fixtures in order to dress up and cover the hole cut into the ceiling where the recessed light fixture is mounted. The faux can trim 108 is actually the housing for both the lamp 102 and the ballast portion 104. This arrangement allows the lamp 102 and the ballast 104 to be situated on opposite sides of the housing 106 thus separating the lamp (heat source) from the ballast (heat shortens the life of the ballast components).

In an exemplary embodiment, the housing/trim 106 is formed from a heat-conductive material in order to transfer heat from the lamp and heat generated by the ballast to ambient air of the room of installation. Exemplary materials for the housing/trim include metals, heat-conductive plastics and the like. In one embodiment, the housing is formed from Aluminum. In other embodiment, the housing/trim is formed from multiple materials.

The lens 110 on the faux can lighting device 100 gives the same light level and similar light patterns as the traditional recessed light fixture with a typical incandescent or compact fluorescent lamp installed. The lens and trim combination look like a traditional recessed fixture while hiding its unique construction. This serves to minimize the acceptance of a new look into the markets such as new housing construction and retail.

In addition to enhanced heat dissipation, another thermo advantage of the faux can device over traditional screw in type compact fluorescent lamps is the relationship of the lamp and ballast to each other. In the faux can device, the light bulb is substantially parallel to the ballast, unlike typical compact fluorescent lamps in which the ballast is situated directly above the lamp. The heat generated by the lamp rises and heats the ballast thereby decreasing the useful life of the device.

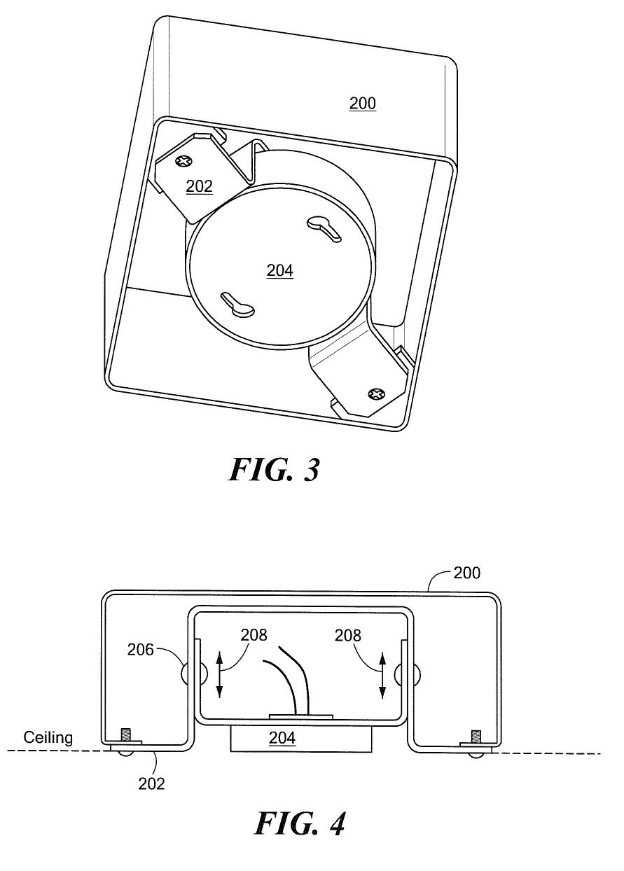

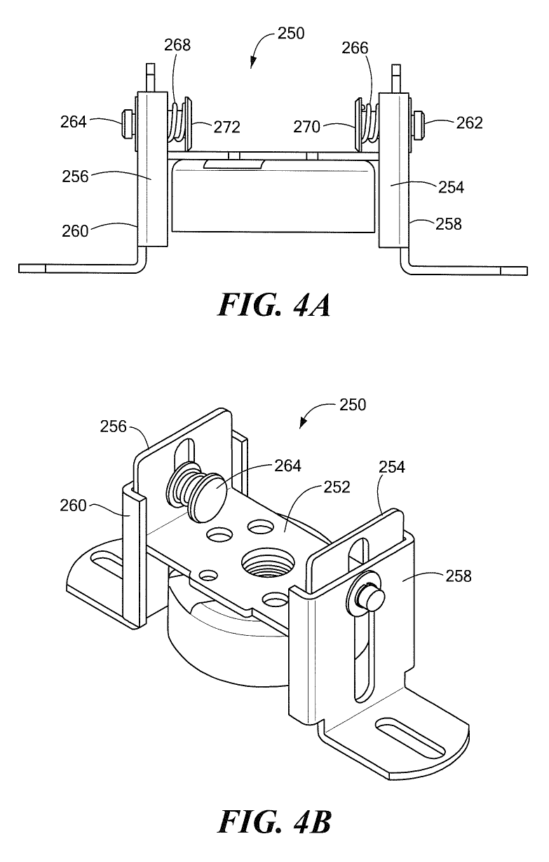

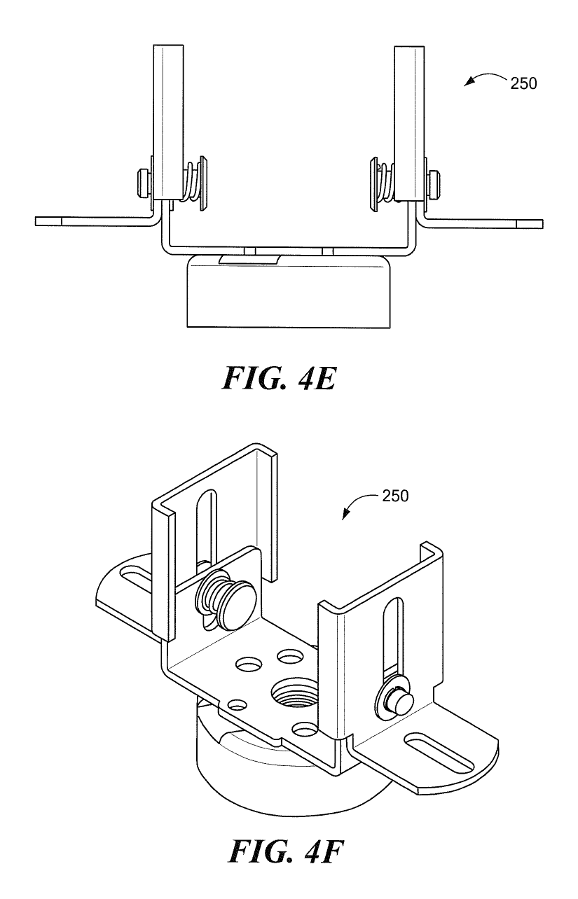

FIGS. 2-4 show lighting device installation in accordance with exemplary embodiments of the invention. To mount a faux can device 100 in new construction one prepares the surface (e.g., ceiling) in the same manner as for mounting a flush mount ceiling fixture (FMCF). They would not prepare the surface in the same manner they would for a recessed lighting fixture, which requires more time and materials. When a contractor/home builder is preparing a room for recessed cans large holes, e.g., round six inch holes (28.26 square inches), are cut into the surface for mounting a deep fixture into the ceiling. The recessed can is then wired to a standard electrical box. In contrast, when installing a faux can device a square four inch hole can be made for a standard four inch electrical box, as shown in FIG. 5.

Referring again to FIGS. 2-4, with the faux can device 100, as well as a FMCF, the contactor/builder only has to mount a standard electrical box 200. A conventional FMCF device requires one to disconnect the wires and reconnect wires when a fixture is no longer desirable. The inventive faux can device mounts to the electrical box 200 with a cross bar 202 that has an integral GU24 socket 204. The GU24 sockets are well known to one of ordinary skill in the art.

The cross bar 202 includes a mechanism 206 that allows the GU24 socket 204 to move into and out of the box 200 as shown by arrows 208 so that the GU24 socket can be positioned as desired in relation to the ceiling (up and down and/or side to side or rocking motion). When the faux can device 100 GU24 socket is engaged, the device trim can be flush with the ceiling. The mechanism can be provided by a variety of know components including set screws, nuts and bolts, detents, interference fits, adhesive, and the like.

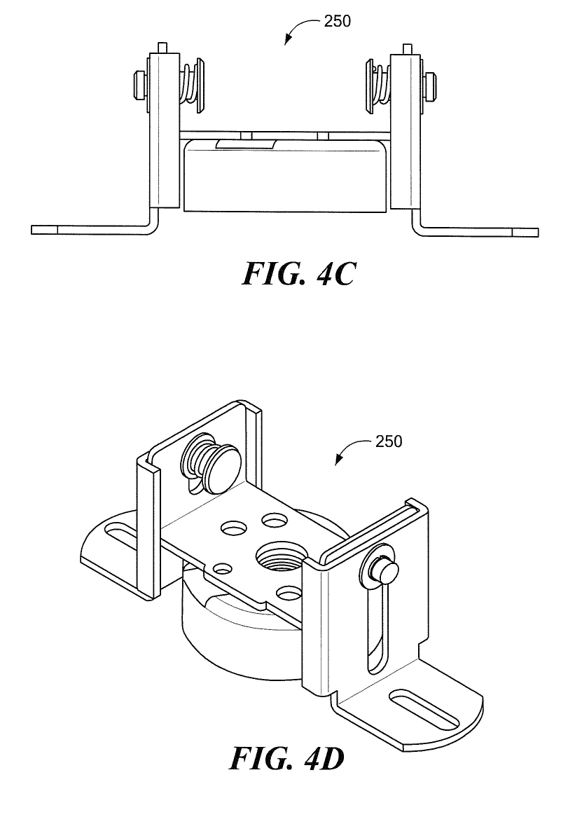

FIGS. 4A-4F show further detail of an exemplary cross bar embodiment 250 comprising a cross bar including a U-shaped member 252 having first and second side members 254, 256 movably coupled to fixed L-shaped base members 258, 260 securable to a ceiling or other surface. In an exemplary embodiment, the side members 254, 256 are coupled to the base members 258, 260 by respective bias members 262, 264 movable in channels formed in the base members. In the illustrated embodiment, the bias members 262, 264 include springs 266, 268 so that an installer can pull out head members 270, 272 to enable the cross bar to be moved up and down with respect to the base members 258, 260. Once the head members are released, the springs 266, 268 secure the cross bar in place.

It is understood that the cross bar embodiment can further enable some degree of side to side/tilting action so that the faux can be completely flush even if the electrical box is not exactly parallel to the ceiling. In new construction, for example, the electrical box is installed in the rafters before the ceiling (sheet rock) is installed. Often the electrical box is not parallel to the ceiling and is likely to be askew. With this arrangement, the faux can device, via the cross bar, can compensate for some lateral ceiling variation.

In an exemplary embodiment, the inventive faux can device includes a flat compact fluorescent lamp (CFL) behind a frosted diffuser, with the electronic ballast located in the trim ring. A GU24 2-pin line voltage connection on the back of the faux can structure facilitates installation into a GU24 receptacle mounted flush to the ceiling.

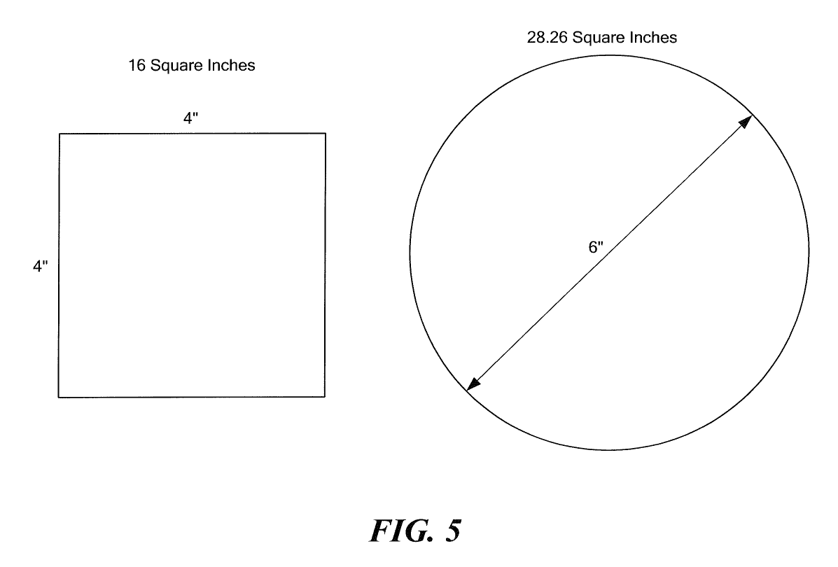

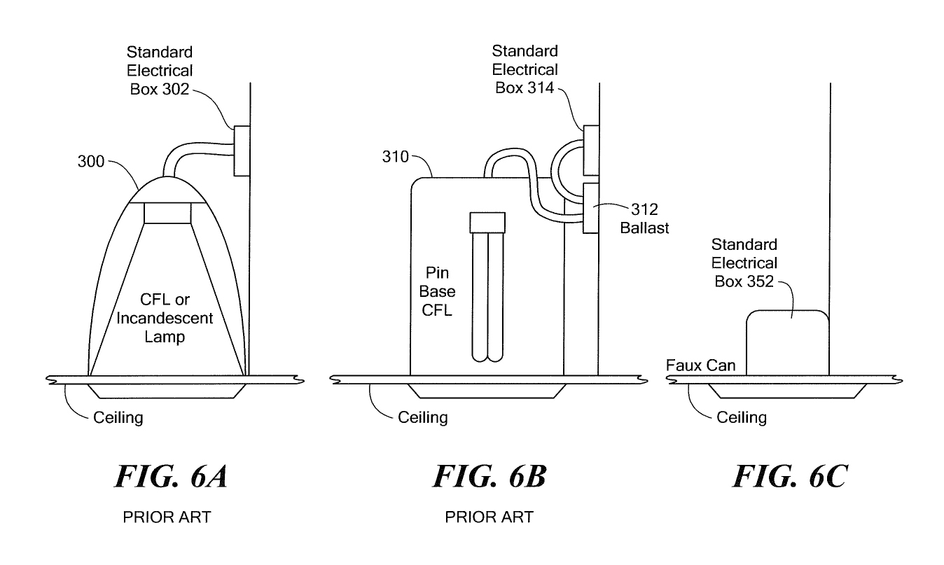

FIGS. 6A and 6B show prior art recessed can installations and FIG. 6C shows an exemplary faux can device installation. FIG. 6A shows a prior art recessed can 300 without a ballast coupled to an electrical box 302. The can 300 is installed in a six inch round hole. FIG. 6B shows a prior art recessed can 310 coupled to a ballast 312, which is coupled to an electrical box 314. The lamp can be a CFL having a pin base.

FIG. 6C shows a faux can device 350 coupled to the electrical box 352 in a four square inch hole in the ceiling. By flush mounting the faux can device and installation in a four inch electrical box, as opposed to a round six inch hole for recessed cans, a 43% reduction in the area of each hole in the ceiling is achieved. This significantly reduces the air infiltration in non-air tight applications and uses significantly less materials to achieve the same result.

It is understood that the faux can device can replace insulation-contact/air-tight (IC/AT) applications as well as non-IC/AT applications.

In general, a variety of suitable lamps can be used in the faux can device. In an exemplary embodiment, a generally flat and approximately round compact fluorescent lamp design is used. It is understood that the lamp is not limited to any particular configuration, but rather, a broad range of shapes and wattages can be used. It is further understood that other types of suitable light sources can be used, such as LED, CCFL and the like.

The present invention provides a faux can downlight that is flush mounted on a ceiling or other surface. Since the faux can extends a small amount from the ceiling, the appearance of a recessed can trim kit is achieved.

It is understood that the distance the faux can extends from the ceiling can vary. In one embodiment, the distance is less than about one inch. In another embodiment, the distance is less than about one-half inch.

The wattage rating the faux can device can vary to meet the needs of a particular application. In one embodiment, the faux can is rated for about 26 Watts. It is understood, however, that other embodiments can be rated for any practical wattage. In addition, further embodiments will include dimming and rated for about 18 Watts.

Various trim kit finishes can be provided. In one embodiment, the trim is permanently given a finish. Alternatively, snap on trim rings can allow easy changing of trim appearance. Exemplary finishes include white, black, brushed nickel, or brushed aluminum, to the style-forward with leopard skin, pink polka dots, etc.

In an exemplary embodiment, the faux can unit is a single self-ballasted lamp unit functioning as a lamp and a fixture. When either the lamp or ballast fail within the sealed unit, the faux can unit is pulled down slightly from the ceiling to the extent the FMCB will allow and twisted out of its GU24 connection and replaced with a new faux can unit. This eliminates troubleshooting, concerns over replacement parts, and is extremely consumer-friendly. Lamp-ballast compatibility concerns are eliminated, as are replacement lamp and ballast availability barriers.

Having described exemplary embodiments of the invention, it will now become apparent to one of ordinary skill in the art that other embodiments incorporating their concepts may also be used. The embodiments contained herein should not be limited to disclosed embodiments but rather should be limited only by the spirit and scope of the appended claims. All publications and references cited herein are expressly incorporated herein by reference in their entirety.

What is claimed is:

1. A downlight lighting device, comprising:
a housing adapted for engagement to a surface;
a ballast integrally coupled to the base and electrically engageable to a CFL, the ballast and the CFL being generally parallel,
wherein the device is configured to be flush mounted on the surface.

2. The device according to claim 1, further including the compact fluorescent lamp (CFL) coupled to the base.

3. The device according to claim 1, wherein the device includes a GU24 plug for coupling with a GU24 socket.

4. The device according to claim 1, wherein the ballast and the lamp are integral to the device such that failure of the ballast and/or lamp is addressed by replacement of the device.

5. The device according to claim 1, wherein a distance the device extends below the surface is less than about one inch.

6. The device according to claim 1, wherein a distance the device extends below the surface is less than about one-half inch.

7. The device according to claim 1, wherein the device flush-mounts to a four inch electrical box.

8. The device according to claim 3, further including a floating and movable cross bar coupled to the GU24 socket to secure the socket to the electrical box.

9. The device according to claim 8, further including a mechanism to enable the GU24 socket to move into and out of the electrical box for flushmounting of the device on the surface.

10. A flush mountable CFL downlight device, comprising:
a housing;
a ballast secured to the housing;
a hard-wired CFL coupled to the housing adapted for being energized by the ballast, wherein the ballast and the CFL are generally parallel; and
a GU24 plug extending from the housing,
wherein the device is flushmountable to a ceiling.

11. The device according to claim 10, wherein the device is configured to extend less than one inch down from the ceiling.

12. The device according to claim 10, wherein the device is configured to extend less than one-half inch down from the ceiling.

13. The device according to claim 10, further including a GU24 socket securable to a four inch electrical box.

14. The device according to claim 13, further including a floating and movable cross bar to secure the GU 24 socket to the electrical box.

15. A method, comprising:
forming a four square inch hole in a ceiling;
installing an electrical box inside the hole; and
flush mounting a CFL downlight device on the ceiling.

16. The method according to claim 15, further including inserting a GU 24 plug extending from the device into a GU24 socket secured to the electrical box.

17. The method according to claim 15, further including securing the GU24 socket to the electrical box with a floatable and movable cross bar.

18. The method according to claim 15, further including adjusting a mechanism to make the device flush with the ceiling.

19. The method according to claim 15, further including mounting the device such that the device extends less than about one inch down from the ceiling.
